(19) United States
(12) Patent Application Publication
(10) Pub. No.: US 2008/0157707 A1
(43) Pub. Date: Jul. 3, 2008

(54) Electric Motor And Method Of Controllling Said Motor

(75) Inventors: Frank Jeske, St. Georgen (DE); Arno Karwath, Deisslingen (DE); Günther Strasser, St. Georgen (DE); Frank Heller, Konigsfeld-Burgberg (DE)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: EBM-PAPST ST. GEORGEN GMBH & CO. KG, St. Georgen (DE)

(21) Appl. No.: 11/817,406

(22) PCT Filed: Feb. 28, 2006
(86) PCT No.: PCT/EP06/01815

§ 371 Date: Oct. 3, 2007

(30) Foreign Application Priority Data
Mar. 4, 2005 (DE) 10 2005 011 263.3

(51) Int. Cl. H02P 6/14; H02P 6/18

(52) U.S. Cl. 318/723

(57) ABSTRACT

The invention relates to a sensorless electric motor and a method of controlling such an electric motor, which motor comprises a permanently magnetic rotor, a stator having at least one winding, and a power stage for influencing the current flowing through the winding. As a function of a predetermined commutation duration (T_K), a commutation period is defined, during which period the direction of the magnetic field generated by current flow through the winding is not modified, during which period a commutation completion operation (107) and a commutation initiation operation (109) take place, and which period starts at a first commutation instant (t_K_{N}) and ends at a second commutation instant (t_K_{N+1}); preferably, commutation timing is adjusted, based upon a value of induced voltage picked up at a currently non-energized one of the winding strands, during a plateau portion (108) of a winding voltage trace, located temporally between commutation instants.

### CROSS-REFERENCE

This application is a section 371 of PCT/EP06/01815, filed 28 Feb. 2006, published 8 Sep. 2006 as WO 2006-092 265-A, and further claims priority from German application DE 10 2005 011 263.3, the contents of which are hereby incorporated by reference.

### FIELD OF THE INVENTION

The invention relates to an electric motor and to a method of controlling it.

### BACKGROUND

It is often required of electric motors that they be low in cost and quiet.

It is therefore an object of the invention to make available a novel electric motor and a novel method of controlling it.

This object is achieved, according to the invention, by distinguishing between a current rise subperiod, a current-constant middle subperiod and a current-drop subperiod during each commutation period, and measuring induced voltage only during the current-constant middle subperiod. The fact that current flow occurs with a substantially constant current enables an adaptation of the commutation duration as a function of a sensed voltage signal, in order to adapt the commutation duration to the rotation speed of the rotor. This enables commutation without additional rotor position sensors, and results in an inexpensive motor.

A preferred refinement is to regulate current rise and current drop gradually so that the signal traces form ramps. Because the commutation duration is ascertained, it is possible to carry out the commutation initiation process and the commutation completion process in the form of ramps. This smooth switching-on and shutoff decreases motor noise, and makes possible a quieter motor.

A further preferred embodiment is to calculate current target values in a digital controller, which applies those values to a current regulator, which in turn controls semiconductor switches in series with the windings. With such a method, rotation speed regulation with an electric motor according to the present invention is possible.

According to a further aspect of the invention, the object is achieved by an electric motor with two winding strands which are energized in alternation, with induced voltage being monitored in the currently non-energized winding strand. An electric motor of this kind allows a method according to the present invention to be carried out, and results in a low-cost and quiet motor.

### BRIEF FIGURE DESCRIPTION

Further details and advantageous refinements of the invention are evident from the exemplifying embodiments, in no way to be understood as a limitation of the invention, that are described below and depicted in the drawings. In the drawings:

FIG. 1 is a schematic circuit diagram of an exemplifying embodiment of an arrangement according to the present invention having a two-strand stator;

FIG. 2 is a circuit diagram of an evaluation device for the induced voltage;

FIG. 3 is a circuit diagram of a motor current regulator;

FIG. 4 depicts the motor current regulated by the motor current regulation system;

FIG. 5 schematically depicts a single-phase, two-strand motor;

FIG. 6 depicts currents and voltages occurring in the motor of FIG. 1;

FIG. 7 schematically depicts a late commutation process;

FIG. 8 is an oscillogram of a late commutation process;

FIG. 9 schematically depicts an early commutation process;

FIG. 10 is an oscillogram of an early commutation process;

FIG. 11 schematically depicts a single-phase, single-strand motor;

FIG. 12 depicts currents and voltages occurring in the motor of FIG. 11;

FIG. 13 schematically depicts a late commutation voltage area;

FIG. 14 is a flow chart of an overall program for controlling a motor according to the present invention;

FIG. 15 schematically depicts a commutation period;

FIG. 16 is a flow chart of a current flow during one commutation period;

FIG. 17 is a flow chart for a timer interrupt routine;

FIG. 18 is a flow chart for generating a rising ramp;

FIG. 19 is a flow chart for generating a falling ramp;

FIG. 20 is a flow chart for a rotation speed regulation system; and

FIG. 21 is a block diagram of a current and rotation-speed regulator.

### DETAILED DESCRIPTION

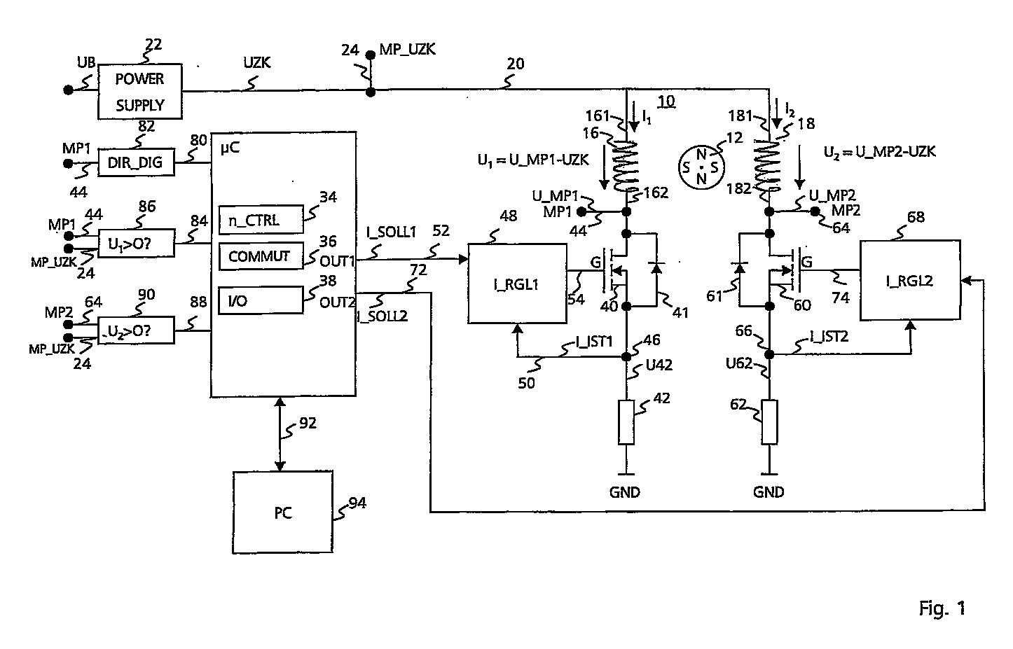

FIG. 1 shows an electric motor 10 having a permanently magnetic rotor 12 and a single-phase, two-strand stator 14 having a winding arrangement 15, which arrangement comprises a first stator strand 16 and a second stator strand 18.

The respective upper ends 161, 181 of strands 16 and 18 are connected via lead 20 to link circuit voltage UZK, which can be picked off via a measurement node MP_UZK 24. Link circuit voltage UZK is generated by a power supply 22 from operating voltage +UB, e.g. from an alternating line voltage or from a battery.

The lower end 162 of first strand 16 is connected via a MOSFET 40 and a measuring resistor 42 to ground GND. The potential at the lower end 162 of first strand 16 is picked off via a measurement node MP1 44. The potential between MOSFET 40 and resistor 42 is picked off via a node 46, and delivered through a lead 50 to a current regulator I_RGL1 48. Current regulator I_RGL1 48 is connected via a lead 52 to a microprocessor μC 32 that delivers a target value signal I_SOLL1 to current regulator I_RGL1 48. Current regulator 48 is connected via a lead 54 to the gate terminal of MOSFET 40 in order to control the latter.

In the same fashion, the lower end 182 of second strand 18 is connected to ground GND via a MOSFET 60 and a measuring resistor 62. The potential at the lower end 182 of second strand 18 is picked off via a measurement node MP2 64. The potential between MOSFET 60 and resistor 62 is picked off via a node 66, and delivered through a lead 70 to a current regulator I_RGL2 68. Current regulator I_RGL2 68 is connected via a lead 72 to microprocessor μC 32 that delivers a target value signal I_SOLL2 to current regulator I_RGL2 68. Current regulator 68 is connected via a lead 74 to the gate terminal of MOSFET 60 in order to control the latter.

Target current value signals I_SOLL1 and I_SOLL2 are preferably specified as analog voltage signals or as PWM (Pulse Width Modulated) signals.

Microprocessor μC 32 is connected via a lead 80 to a rotation direction indicator circuit “DIR DIG” 82, via a lead 84 to a “U1>0?” circuit 86 for detecting the sign of voltage U1, and via a lead 88 to a “U2>0?” circuit 90 for detecting the sign of voltage U2. Rotation direction indicator circuit “DIR DIG” 82 is connected to measurement node MP1 44, the “U1>0?” circuit is connected to measurement nodes MP1 44 and MP_UZK 24, and the “U2>0?” circuit is connected to measurement nodes MP2 64 and MP_UZK 24.

Operating data such as, for example, a target rotation speed n_s are delivered to microprocessor μC 32 via a bidirectional data bus 92, and the program executing in microprocessor μC 32 controls the rotation speed (n_CTRL), commutation (COMMUT), and input/output (I/O).

Examples of component values:

| | |
|---|---|
| μC 32 | PIC16F873A (Microchip Inc, Chandler AZ) |
| MOSFETs 40, 60 | SPB47N10 (with integrated recovery diode) |
| Resistors 42, 62 | 1.5 ohm |

### Operation

Rotor 12 is driven by the fact that current flows alternatingly in strands 16 and 18. The current is controlled by MOSFETs 40 and 60, and current regulation takes place by way of current regulators 48 and 68. Electric motor 10 according to the present invention works in sensorless fashion, i.e. no rotor position sensor such as, for example, a Hall sensor, is provided. The rotation direction is determined via rotation direction indicator circuit 82 from the potential at measurement node MP1 or MP2, and commutation (i.e. the alternation between current flow in the first and the second strand) is effected by measuring and evaluating voltages U1 and U2.

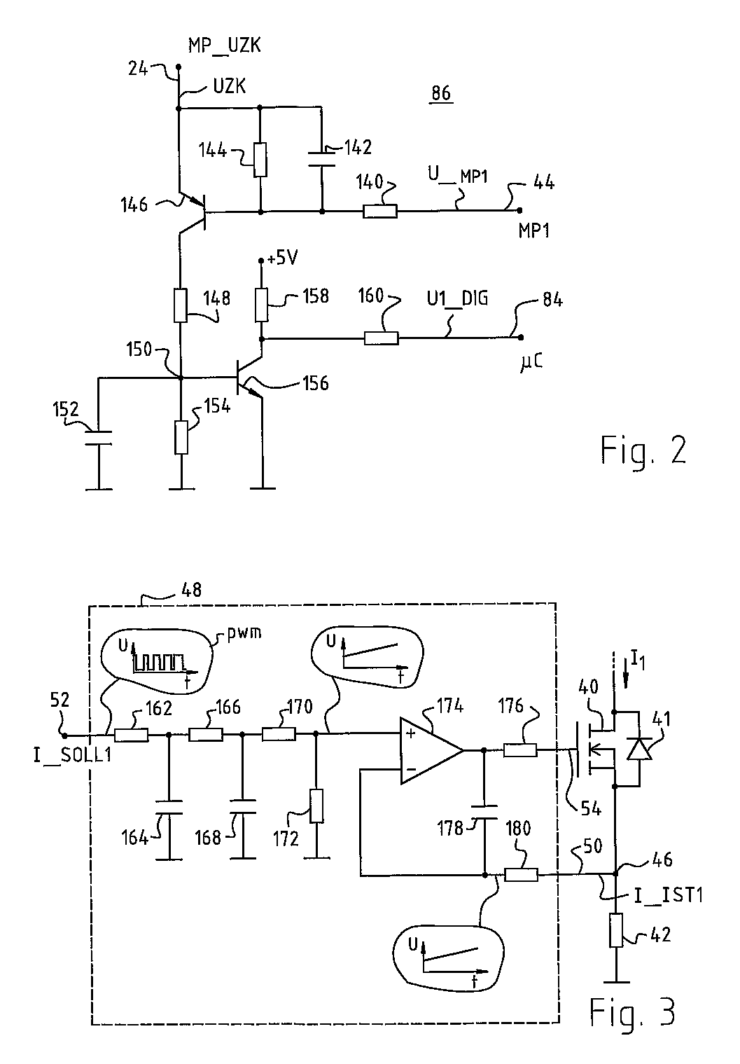

FIG. 2 shows an exemplifying embodiment of the “U1>0?” circuit 86. Circuit 86 comprises a resistor 140 that is connected on one side to measurement node MP1 44 and on the other side to the base of a pnp transistor 146. A capacitor 142 and a resistor 144 are each connected on one side to the base of transistor 146 and on the other side to measurement node MP_UZK 24. The emitter of transistor 146 is likewise connected to measurement node 24. The collector of transistor 146 is connected via a resistor 148 to a node 150. Node 150 is connected to ground GND via a capacitor 152 and a resistor 154. Measurement node 150 is also connected to the base of an npn transistor 156. The emitter of transistor 156 is connected to ground GND, and the collector of transistor 156 is connected via a resistor 158 to a voltage “+5 V” and via a resistor 160 to lead 84 that goes to μC 32.

Signal U_MP1 picked off via measurement node MP1 is delivered, through resistor 140 and (in order to filter interference voltage spikes) through the low-pass filter constituted by resistor 144 and capacitor 142, to the base of transistor 146. When signal U_MP1 is less than signal UZK, transistor 146 conducts. Conversely, when signal U_MP1 is greater than signal UZK, transistor 146 blocks. When transistor 146 blocks, the base of transistor 156 is pulled to ground, and the latter transistor likewise blocks. Lead 84 is thereby pulled to +5 V, and this means a High signal for μC 32. When transistor 146 conducts, on the other hand, resistors 148 and 154 then act as a voltage divider and raise the potential at the base of transistor 156. Transistor 156 becomes conductive as a result, and lead 84 is pulled to ground GND, which corresponds to a Low signal for μC 32.

The sign of the voltage

U1=U_{—}MP1−UZK

is converted by circuit 86 into a digital signal U1_DIG. When U1>0 V, U1_DIG=High, and when U1<=0 V, U1_DIG=Low. This allows simple evaluation of voltage U1 by μC 32.

The “U2>0?” circuit 90 is preferably constructed in the same fashion.

Examples of component values:

| Resistor 140 | 47 | kilohm |
|---|---|---|
| Capacitor 142 | 470 | pF |
| Resistor 144 | 470 | kilohm |
| pnp Transistor 146 | PMBTA92 | |
| Resistor 148 | 68 | kilohm |
| Capacitor 152 | 1 | nF |
| Resistor 154 | 10 | kilohm |
| npn Transistor 156 | BC846B | |
| Resistor 158 | 4.7 | kilohm |
| Resistor 160 | 1 | kilohm |

FIG. 3 shows an exemplifying embodiment of the “I_RGL1” circuit 48, to which a target current value signal I_SOLL1 is delivered from μC 32, and to which a signal I_IST1 is delivered via lead 50 from base resistor 42. Circuit 48 controls MOSFET 40 via lead 54. Signal I_SOLL1 is delivered to an operational amplifier 174 through three resistors 162, 166, and 170 connected in series. A capacitor 164 is connected to ground between resistors 162 and 166, and a capacitor 168 is connected to ground between resistors 166 and 170. Between resistor 170 and the positive input of operational amplifier 174, a resistor 172 is connected to ground.

Signal I_IST1 is delivered to the negative input of operational amplifier 174 through a resistor 180. The output of operational amplifier 174 is connected via a resistor 176 to the gate terminal of MOSFET 40. The negative input and the output of operational amplifier 174 are connected via a capacitor 178.

In this exemplifying embodiment, target value signal I_SOLL1 is specified by μC 32 as a PWM signal pwm. The PWM signal is smoothed by the low-pass filter constituted by resistors 162, 166, and 170 and capacitors 164 and 168, and delivered to the positive input of operational amplifier 174. Motor current I1 is measured via base resistor 42, and the potential at node 46 is delivered through resistor 180 to the negative input of operational amplifier 174. Operational amplifier 174 controls the gate terminal of MOSFET 40 via resistor 176, and thus performs a current regulation of current I1 in such a way that the potential at node 46 corresponds to target current value I_SOLL1.

The utilization of an analog current regulator allows the use of a simple μC 32, since the latter needs to carry out only the calculation of target current value I_SOLL1. Alternatively, a digital current regulator can also be used, with which actual current value I_IST1 is delivered to μC 32 in suitable form.

Current regulator “I_RGL2” 68 is preferably constructed in the same manner as current regulator “I_RGL1” 48.

Examples of component values:

| Resistor 162 | 22 | kilohm |
|---|---|---|
| Capacitor 164 | 10 | nF |
| Resistors 166, 170 | 10 | kilohm |
| Resistor 172 | 1.8 | kilohm |
| Operational amplifier 174 | TSH24 | |
| Resistor 176 | 220 | ohm |
| Capacitor 178 | 22 | pF |
| Resistor 180 | 10 | kilohm |

FIG. 4 shows target current value signal I_SOLL1 as a line 105, and motor current I1, regulated by analog current regulator 48 in accordance with the target current value signal, as a line 100. Motor current I1 thus substantially tracks target value I_SOLL1, i.e. it rises in the form of a rising ramp 107 then, with a constant target current value signal I_SOLL1, proceeds substantially constantly in the form of a plateau 108, and then drops toward 0 V in the form of a falling ramp 109. A shape of this kind is also called a trapezoidal shape. As is evident from plateau 108, current regulator 48 initially overshoots slightly and motor current I1 drops slightly. This is usual for simple current regulators, and a motor current of this kind can nevertheless be referred to as constant, and in any case as substantially constant. The current regulator can also regulate motor current I1 to a value of 0 A.

In contrast to a “hard” switch-on and shutoff of current I1, switching on and shutting off current I1 in the form of a ramp generates less noise.

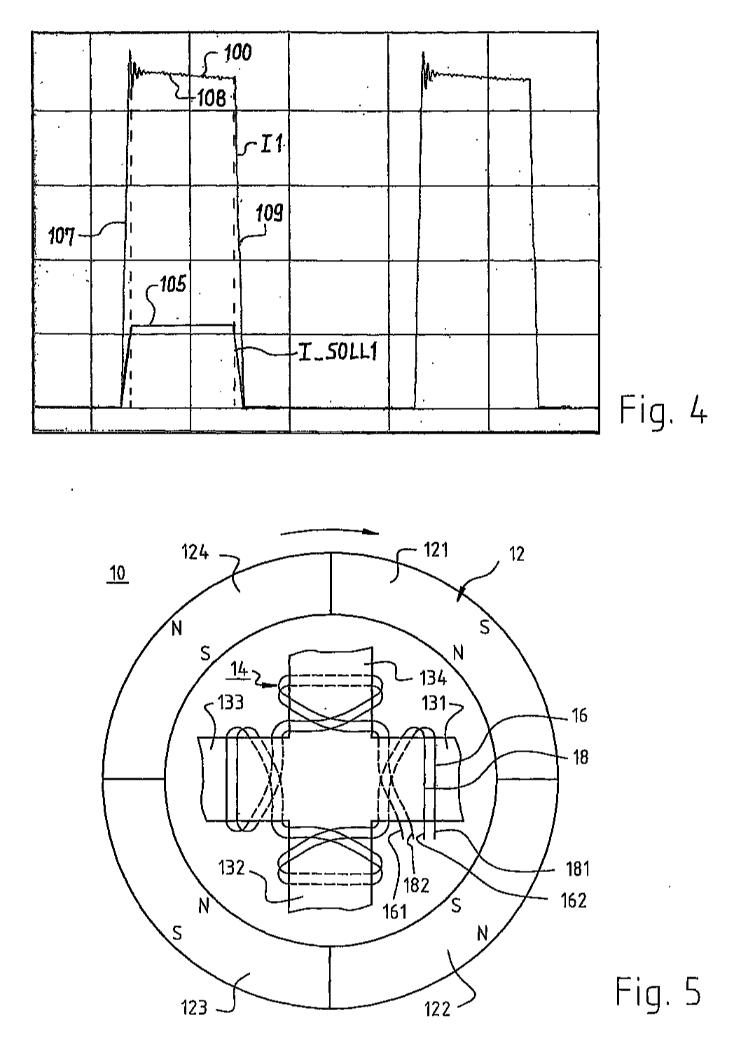

FIG. 5 schematically depicts stator 14 and permanently magnetic rotor 12. External rotor 12 comprises four poles 121, 122, 123, and 124. Stator 14 is made of soft ferromagnetic material and likewise comprises four poles 131, 132, 133, and 134, whose polarity is determined by the motor current flowing through stator strand 16 or 18. Stator strands 16 and 18 are wound in bifilar fashion for cost reduction, and oppositely directed magnetic-field generation is achieved by the fact that the link circuit voltage is applied at beginning 161 of the winding wire in the case of first strand 16, and at end 181 of the winding wire in the case of second strand 18. In motor 10 that is depicted, the voltage induced by a rotation of rotor 12 depends on the rotation angle.

### Commutation

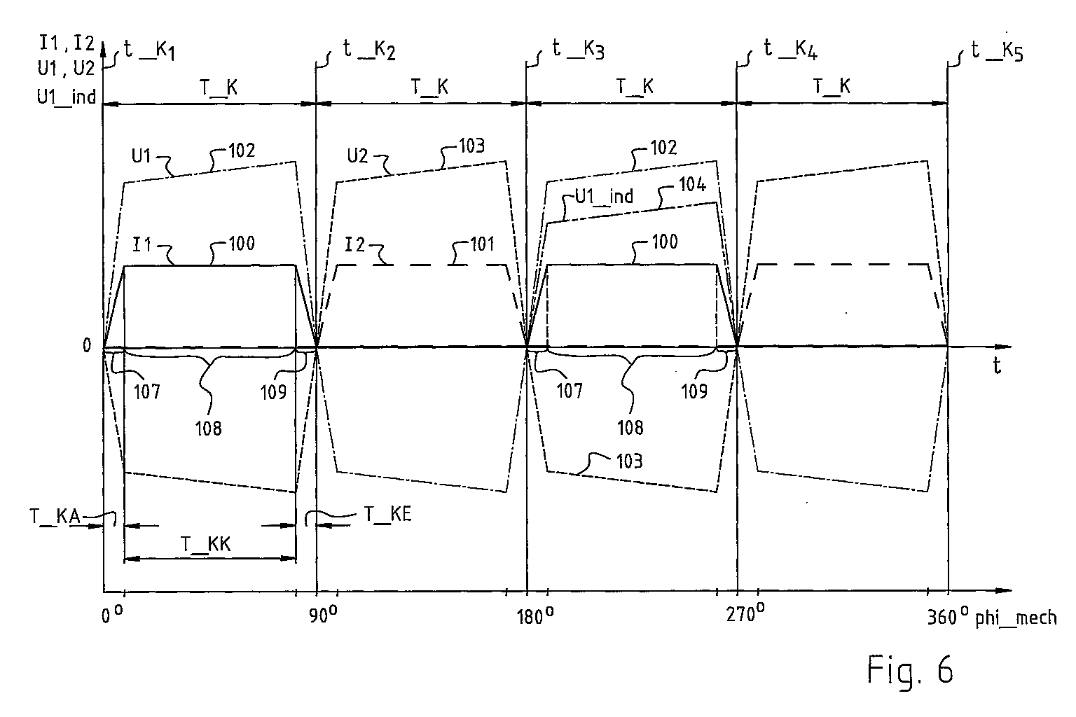

FIG. 6 schematically depicts the current flow through stator 14 of FIG. 5 over one complete revolution of rotor 12 (360° mech.). Current I1 through stator strand 16 is depicted as a line 100, current I2 through stator strand 18 as line 101, voltage U1 present at stator strand 16 as line 102, and voltage U2 present at stator strand 18 as line 103.

Four commutation periods (720° el.) are depicted, which extend between commutation instants t_K1 and t_K2, t_K2 and t_K3, t_K3 and t_K4, and t_K4 and t_K5. In general, the respective first commutation instant for a commutation period will be referred to hereinafter as t_K_{N}, and the respective second commutation instant as t_Kₙ₊₁. The commutation duration of the respective commutation periods is referred to as T_K. Only one of stator strands 16 and 18 of winding 15 experiences current flow during a commutation period, so that the direction of the magnetic field generated by the current flow of winding 15 does not change during that commutation period. Currents I1 and I2 flow alternatingly through stator strands 16 and 18.

During each commutation period, one commutation completion operation 107, one operation 108 at substantially constant current flow, and one commutation initiation operation 109 take place. In this exemplifying embodiment, commutation completion operation 107 begins after commutation instant t_K_{N}, and current I1 or I2 rises in the form of a ramp during commutation completion operation 107. The duration of the commutation completion operation is labeled T_KA. Commutation completion operation 107 is followed by a time phase 108 with constant current flow, for a duration T_KK. Following time phase 108 with substantially constant current flow is commutation initiation operation 109, during which (in this exemplifying embodiment) current I1 or I2 is decreased in the form of a ramp until it reaches a value of 0 V. The duration for the commutation initiation operation is labeled T_KE.

Voltages U1 at stator strand 16 and U2 at stator strand 18 can contain, in particular, the following components:

U1=U1_{—}ind+L₁₁*dI1/dt+I1*R1+L₁₂*dI2/dt (1)

U2=U2_{—}ind+L₂₂*dI2/dt+I2*R2+IL₂₁*dI1/dt (2)

where

U1=voltage at stator strand 16

U2=voltage at stator strand 18

U1_ind=voltage induced in stator strand 16 by the rotating permanently magnetic rotor 12

U2_ind=voltage induced in stator strand 18 by the rotating permanently magnetic rotor 12

L₁₁=self−inductance of stator strand 16

L₂₂=self−inductance of stator strand 18

I1=current through stator strand 16

I2=current through stator strand 18

R1=ohmic resistance of stator strand 16

R2=ohmic resistance of stator strand 18

L₁₂=mutual inductance between stator strand 18 and stator strand 16

L₂₁=mutual inductance between stator strand 16 and stator strand 18

When a constant current I1 flows through stator strand 16 and when current I2=0 (time phase 108), the time-dependent terms drop out of equations (1) and (2) and what remains is:

U1=U1_{—}ind+I1*R1 (3)

U2=U2_ind (4)

In the same fashion, what applies when stator strand 18 has a constant current I2 flowing through it, and current I1=0, is:

U1=U1_ind (5)

U2=U2_{—}ind+I2*R2 (6)

For a single-phase, two-strand motor with constant current flow through a first winding strand, the induced voltage U_ind can thus be sensed at the respective winding strand through which current is not flowing. During the commutation operation, on the other hand, such sensing would generally be impossible, or possible only very inaccurately, because of the changing current I1 or I2.

The commutation period between commutation instant t_K3 and commutation instant t_K4 will be considered below. During time phase 108 with constant current flow through stator strand 16, voltage U1 at stator strand 16 is made up, according to equation (3), of induced voltage U1_ind (depicted as line 104) and a magnitude I1*R1 that is constant because current I1 is constant. Voltage U1 therefore does not correspond directly to induced voltage U1_ind. But because current I2 is equal to 0 A, voltage U2 at stator strand 18 corresponds, during time phase 108 of constant current flow, to induced voltage U2_ind, the following being applicable because of the winding 15 selected according to FIG. 5:

U1_{—}ind=−U2_{—}ind (7)

Voltages U1 and U2 rise slightly during time phase 108 of constant current flow because motor 10 is configured to generate an auxiliary reluctance torque. For a motor of this kind, induced voltages U1_ind and U2_ind are dependent (for a uniform rotation speed) on the instantaneous rotation angle phi_mech, since stator poles 131, 132, 133, and 134 are configured asymmetrically, as indicated very schematically in FIG. 5. The slight slope of voltages U1 and U2 allows the rotation direction of rotor 12 to be detected. In the one rotation direction the respective induced voltage rises, and in the opposite rotation direction the respective voltage falls.

In the exemplifying embodiment of FIG. 6, electric motor 10 is being driven, and after every 90° mechanical or 180° electrical, the current flow is switched from one stator strand to the other stator strand. A prerequisite for this, however, is that commutation duration T_K correspond exactly to the time required by rotor 12 for one rotation of 90° mechanical. Because commutation duration T_K becomes shorter during each commutation period upon startup or acceleration of motor 10, changes upon a change in a load being driven or braked by motor 10, or is modified by a change in the magnitude of current I1 or I2, an adaptation of commutation duration T_K to the present operating state of motor 10 must constantly be performed. This can be accomplished, for example, with rotor position sensors. What will be described below, however, is a method in which the adaptation of commutation duration T_K is accomplished via an evaluation of voltages U1 and/or U2.

### Late Commutation Operation

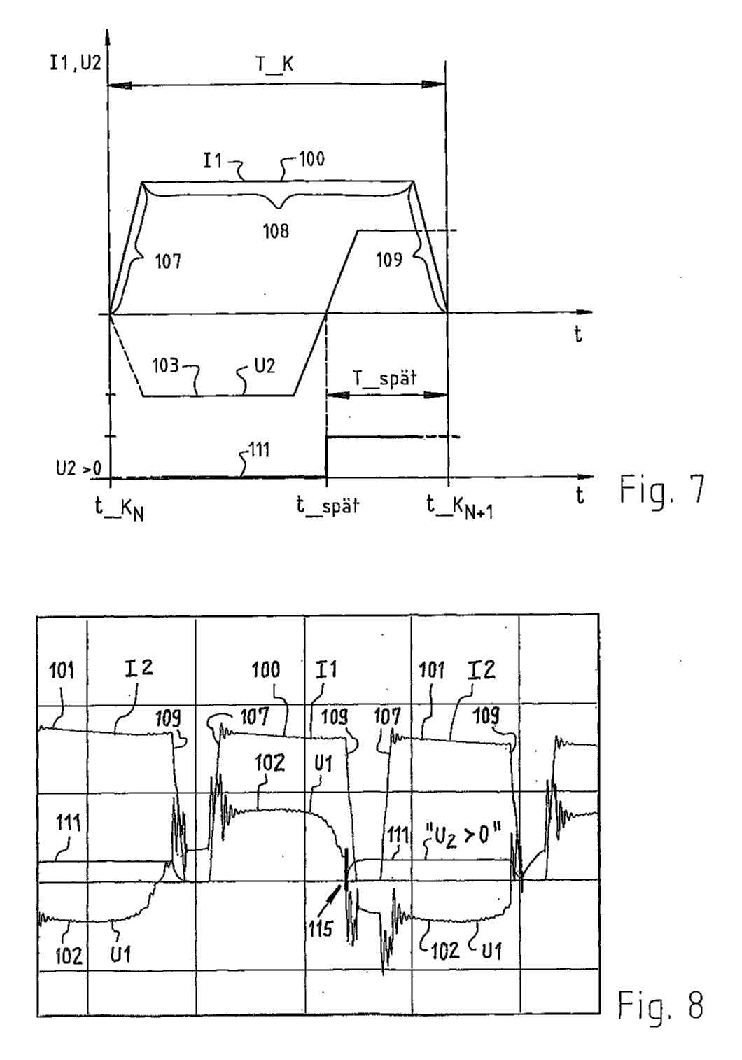

FIG. 7 is a schematic diagram in which current I1 is depicted as line 100, voltage U2 as line 103, and the “U2>0” signal generated by apparatus 90 as line 111. In this example, commutation duration T_K is too long, and commutation therefore takes place not after one revolution of 180° el., but instead too late. A change in the sign of voltage U2 thus already takes place during time phase 108 with constant current flow, and voltage U2, which at this point in time corresponds to induced voltage U2_ind, ends up in an area U2>0 that is unsuitable for this commutation period, resulting in braking of motor 10.

At the moment of the change in sign of voltage U2, the “U2>0” signal 111 jumps from Low to High. The instant of the change is referred to hereinafter as late commutation instant t_spat.

Commutation duration T_K can be corrected by subtracting late commutation duration T_spät from it. Late commutation duration T_spät is obtained from the time span between late commutation instant t_spät and the commutation instant t_K_{N+1} predetermined by commutation duration T_K. The correct commutation duration T_K is also obtained directly from the time span between commutation instant t_K_{N} and instant t_spät.

An operation of this kind, in which voltage U1 or U2 assumes, during duration T_KK of constant current flow, a value from an area unsuitable for the selected operating mode of motor 10 for the particular commutation period, is referred to as a late commutation operation.

FIG. 8 shows an example of a measurement for a late commutation operation such as the one depicted in FIG. 7. Current I1 is depicted as line 100, current I2 as line 101, voltage U1 as line 102, and signal “U2>0” as line 111. At point 115, signal “U2>0” becomes positive shortly before constant current flow through stator strand 106 ends. This means that commutation duration T_K is too long, and a late commutation operation exists.

It is also apparent that voltage U1, and thus also voltage U2, exhibit large disturbances during ramps 107 and 109 because of the regulator and the changes in over time in the current, and said voltages are therefore unsuitable, or only poorly suitable for evaluating induced voltage U1_ind or U2_ind.

### Early Commutation Operation

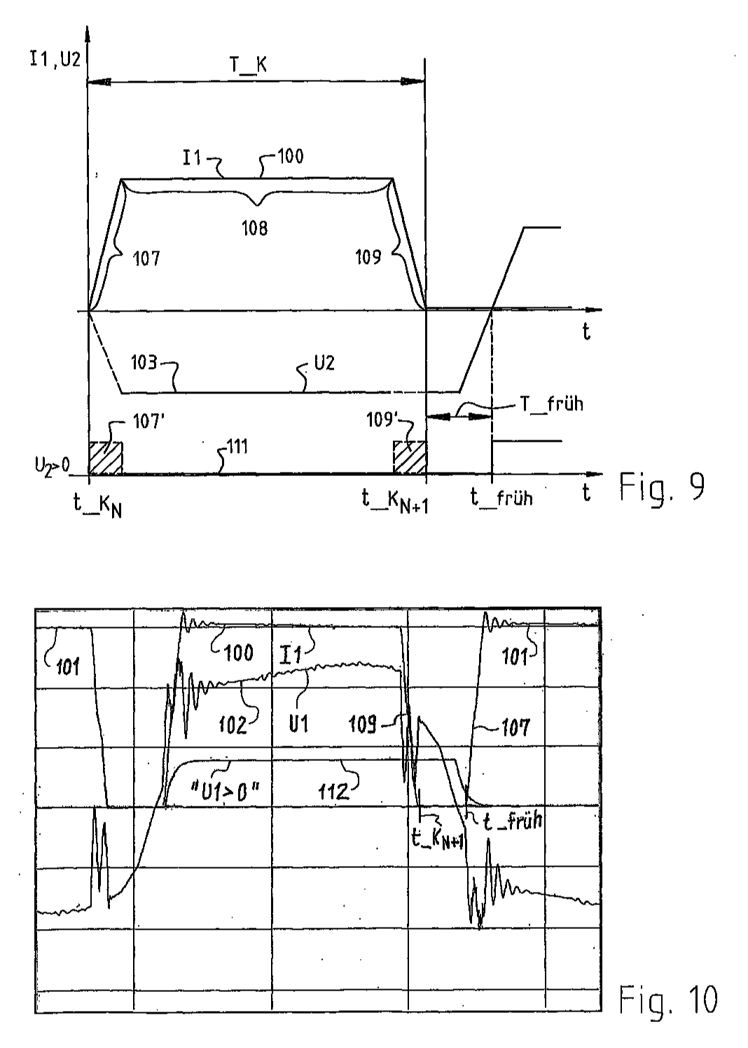

FIG. 9 is a schematic diagram in which current I1 is depicted as line 100, voltage U2 as line 103, and the “U2>0?” signal generated by apparatus 90 as line 111. In this example, commutation duration T_K is too short. The result of this is that induced voltage U1_ind or U2_ind does not, as in the ideal case, exhibit a sign change at commutation instant t_K_{N+1}, but instead the sign change takes place only after an early commutation duration T_früh.

Because both I1=0 and I2=0 after commutation initiation operation 109, both U1 and U2 correspond to the induced voltage (cf. equations (3) and (4)). In this exemplifying embodiment, the induced voltage is measured via voltage U2. The latter exhibits a sign change at instant t_früh, and the “U2>0?” signal 111 changes from Low to High at instant t_früh.

Commutation duration T_K can be corrected by increasing it by an amount equal to early commutation duration T_früh. Early commutation duration T_früh is obtained from the time span between early commutation instant t_früh and the commutation instant t_K_{N+1} predetermined by commutation duration T_K. Instead of commutation instant t_K_{N+1} it is also generally possible to use the point in time at which commutation initiation operation 109 ends.

An operation of this kind, in which voltage U1 or U2 assumes, at the end of commutation initiation operation 109, a value from an area unsuitable for the device operating mode of motor 10 for the particular commutation period, is referred to as an early commutation operation.

FIG. 10 shows an example of a measurement for an early commutation operation such as the one depicted in FIG. 9. Current I1 is depicted as line 100, current I2 as line 101, voltage U1 as line 102, and the “U1>0” signal as line 112. As explained in the description for FIG. 9, the induced voltage after the completion of commutation initiation operation 109 can also be measured via voltage U1, which performs a sign change from High to Low at early commutation instant t_früh.

It is also apparent that voltage U1 exhibits large interference spikes during commutation initiation operation 109, making it very difficult or impossible to evaluate the induced voltage during commutation initiation operation 109. The interference during commutation initiation operation 109 also occurs as a result of the work of the current regulator that converts current I1 to the value I1=0 V in a predetermined form.

At instant t_früh, a change in the “U1>0?” signal 112 from High to Low is detected. After this detection, in this exemplifying embodiment, commutation completion operation 107 is performed, i.e. current flow through stator strand 18 begins. Instant t_früh is preferably selected as first commutation instant t_K_{N+1} for calculating the next commutation instant t_K_{N+2}.

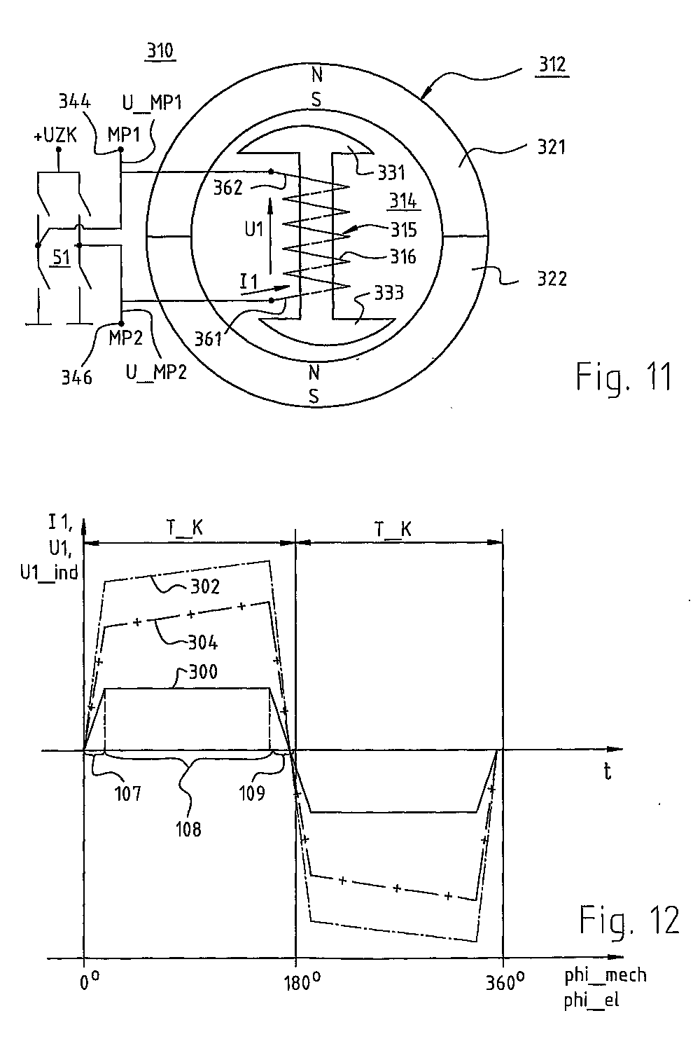

FIG. 11 shows an electric motor 310 having a single-phase, single-strand stator 314 and a two-pole rotor 312. Rotor 312 comprises a first rotor pole 321 and an oppositely magnetized second rotor pole 322. Stator 314 comprises a first pole 331 and a second pole 333, as well as a winding 315. Winding 315 comprises a stator strand 316 that is connected via two terminals 361 and 362 to a schematically indicated power stage 51. Power stage 51 is preferably configured as a full-bridge circuit, in order to allow current flow through strand 316 in both directions. The current through strand 316 is designated I1, and the voltage drop at stator strand 316 as U1.

Voltage U1 is preferably measured via two measurement nodes MP1 344 and MP2 346 that are arranged at the opposite ends of stator strand 316, and at which voltages U_MP1 and U_MP2 are present. Voltage U1 is calculated as

U1=U_{—}MP2−U_{—}MP1 (8).

FIG. 12 depicts current I1 as line 300, voltage U1 as line 302, and voltage U1_ind induced in stator strand 316 as line 304. During one commutation period of length T_K, as in the exemplifying embodiment with two strands, one commutation completion operation 107, one operation 108 with constant current flow, and one commutation initiation operation 109 take place. During operation 108 with constant current flow, voltage U1 is made up, according to equation (3), of induced voltage U1_ind induced in stator strand 316 by the rotating permanently magnetic rotor 312, and a constant factor I1*R1 dependent on the magnitude of constant current I1.

For the check as to whether a late commutation operation exists, the I1*R1 component is subtracted from voltage U1. Either the target value for the corresponding current regulator can be used as a value of current I1, or it is ascertained by a measuring apparatus for current.

### Late Commutation Voltage Area and Early Commutation Voltage Area

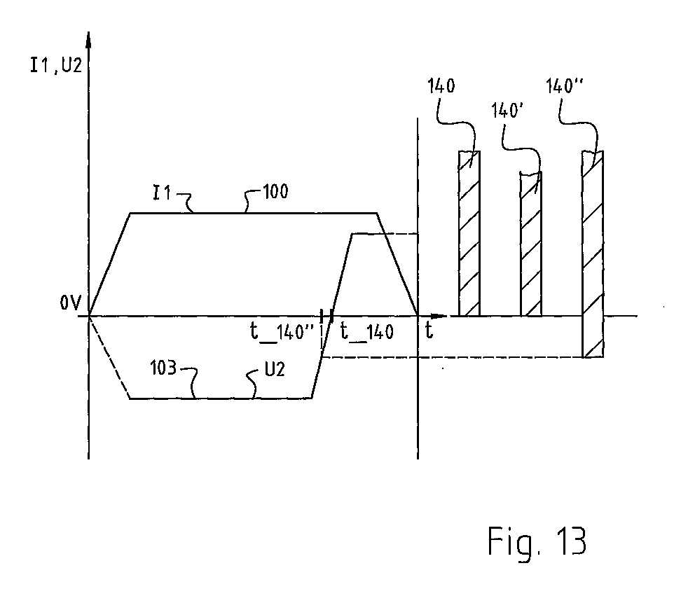

FIG. 13 shows a late commutation operation. A current I1 is plotted as line 100, and a voltage U2 as line 103. A late commutation voltage area 140 is defined for detection of a late commutation operation. Late commutation voltage area 140 begins at 0 V and encompasses the entire positive area. To clarify as to whether a late commutation operation exists, a check is made as to whether the value of voltage signal U2 is within late commutation voltage area 140. This is the case at instant t_140, and a late commutation operation is thus taking place.

Late commutation area 140 can be defined in different ways. Two late commutation voltage areas 140′ and 140′ are presented as further exemplifying embodiments. In contrast to late commutation area 140, late commutation area 140′ is not open toward the top, but ends at a maximum voltage. This allows, if applicable, a simpler evaluation circuit. Late commutation voltage area 140′, on the other hand, begins not at 0 V but at a negative (or positive) voltage. This can be utilized, for example, for earlier detection of a late commutation operation. Detection occurs here at instant t_140″, which is located earlier in time than instant t_140. A shift of this kind can furthermore, for example, take into account an offset of voltage U2 that can occur in a single-strand motor as a result of component I1*R1.

An early commutation voltage area can be defined in the same fashion for the early commutation operation.

### Software Control System of the Motor

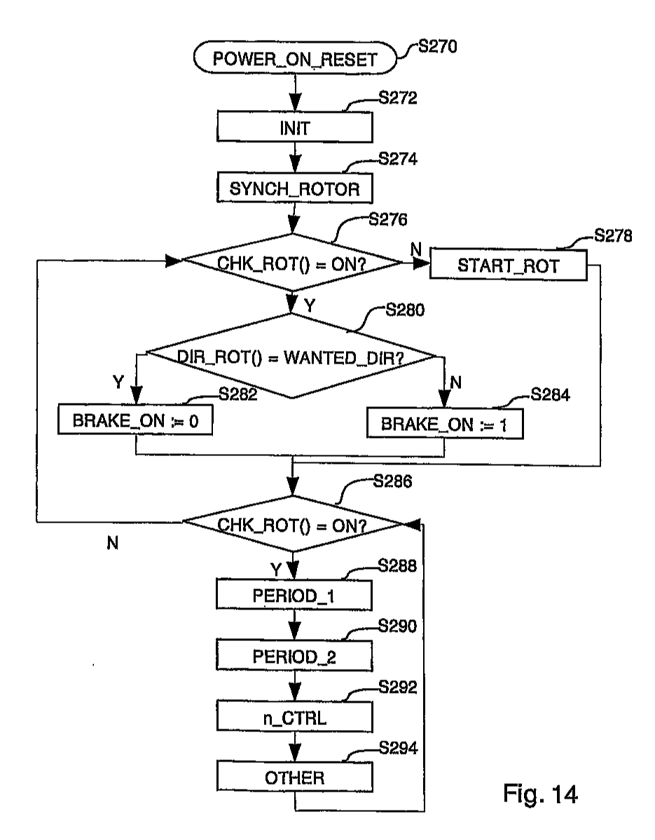

FIG. 14 shows the main program that executes in μC 32. The program begins with the “POWER ON_RESET” step S270, to which μC 32 branches after switch-on. In the “INIT” step S272, variables are initialized and operating parameters are polled, for example via data line 92 of FIG. 1. In the “SYNCH_ROTOR” step S274, execution of the program is synchronized with a rotation (if present) of the rotor, so that said rotation can be utilized as applicable. In step S276, a “CHK_ROT( )” routine checks whether or not the rotor is rotating. If the rotor is rotating, step S280 checks whether it is rotating in the desired direction. In the case of a motor with reluctance torque this can be ascertained as described above, for example, by way of the slope of the induced voltage. If the rotor is rotating in the correct direction, in step S282 a BRAKE_ON variable is set to 0. This indicates that the rotor is already rotating in the correct direction, and a normal commutation can be performed. If the rotor is rotating in the wrong direction, however, then in step S284 the BRAKE_ON variable is set to 1. This indicates that a deceleration of the rotor needs to be accomplished. This can be done, for example, by causing current to flow in the opposite direction in the corresponding commutation period.

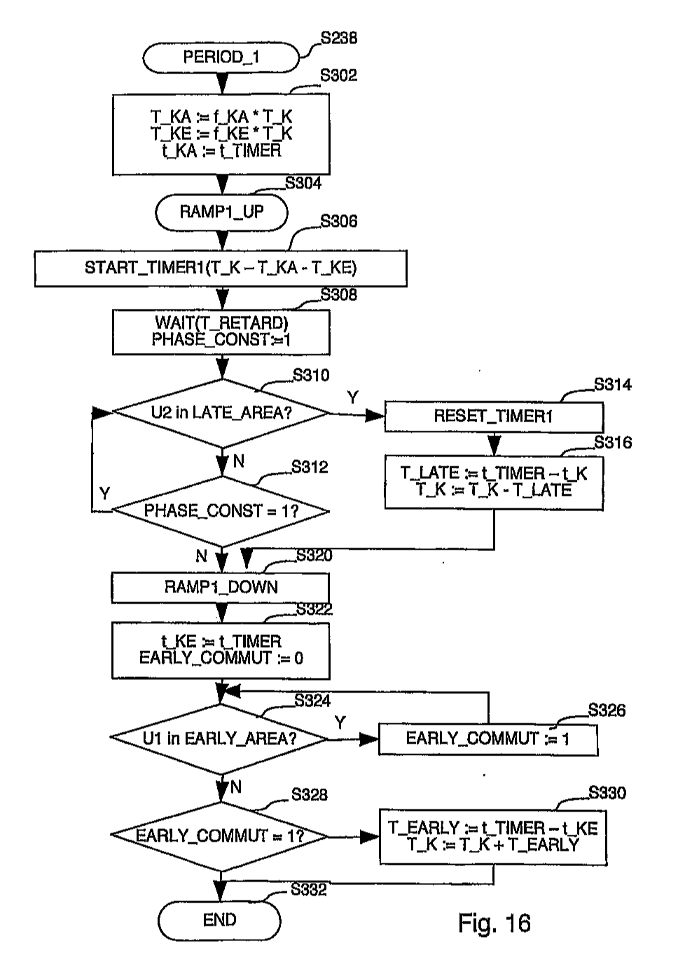

If a rotor standstill is identified in step S276, then in the “START_ROT” step S278 the rotor is caused to move by current flow. The main loop begins in step S286, and a check is made as to whether the rotor is still moving. If this is not the case, execution branches back to step S276. If the rotor is rotating, however, then in the “PERIOD_{—}1” step S288 current flow is performed for the first commutation period. The PERIOD_{—}1 routine is set forth in more detail in FIG. 16.

In the “PERIOD_{—}2” step S290, current flow is performed for the second commutation period, i.e. in the opposite direction. In the “n_CTRL” step S292, the rotation speed regulation calculation operation takes place. This is presented in more detail in FIG. 20.

In the “OTHER” step S294, further steps necessary for operation of the motor take place. For example, input/output is performed, and error signals are outputted in the event of an error.

After step S294, execution branches back to step S286 and the next current flow takes place.

### Ramp

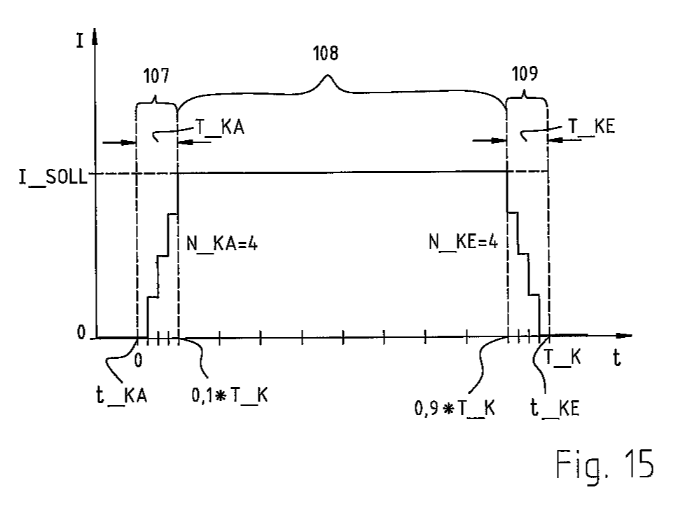

FIG. 15 shows an exemplifying embodiment for a commutation operation in which current flow is taking place through stator strand 16 of FIG. 1.

In a commutation completion operation 107, current I1 is elevated in four steps (N_KA=4) from the value I1=0 A to the value corresponding to target value I_SOLL. This is followed by a time phase 108 during which a constant current flow occurs at the value I1=I_SOLL. Following this is commutation initiation operation 109, during which current I1 is decreased in four steps (N_KE=4), in ramped fashion, from the value I1=I_SOLL to the value I1=0.

In this exemplifying embodiment, duration T_KA of commutation completion operation 107 and duration T_KE of commutation initiation operation 109 are calculated from commutation duration T_K. Commutation completion duration T_KA and commutation initiation duration T_KE are selected so that they each occupy 10% of the total commutation duration T_K. Time phase 108 of constant current flow occupies the remaining 80% of the commutation duration. In general, the values T_KA and T_KE are selected as follows:

T_{—}KA=f_{—}KA*T_{—}K (9)

T_{—}KE=f_{—}KE*T_{—}K (10)

where

T_KA=commutation completion duration

f_KA=proportional factor for the commutation completion duration

T_K=total commutation duration

T_KE=commutation initiation duration

f_KE=proportional factor for the commutation initiation duration.

The proportional factors f_KA and f_KE are preferably adapted to the particular motor type and the particular intended application of electric motor 10, and can be specified to μC 32, for example, by control unit 94 via interface 92 (cf. FIG. 1).

FIG. 16 shows the “PERIOD_{—}1” routine S238. In step S302, commutation completion duration T_KA and commutation initiation duration T_KE are calculated, and variable t_KA is set to the instantaneous time value t_TIMER. Commutation completion instant t_KA corresponds here to the starting instant of the commutation completion operation. In step S304, the “RAMP1_UP” commutation completion operation is performed. This is described in FIG. 18. After the end of the commutation completion operation, a timer TIMER1 is started via a “START_TIMER1” function. Timer TIMER1 measures the time span for the time phase of constant current flow, which is equal to the commutation duration T_K minus commutation completion duration T_KA and commutation initiation duration T_KE. After this time has elapsed, timer TIMER1 generates an interrupt that calls an interrupt routine “TIMER1_INTERRUPT” S250, depicted in FIG. 20. In step S308, execution is delayed for a duration T_RETARD, so that the measurement as to whether a late commutation operation exists does not occur immediately. This prevents errors due to the previously performed commutation completion operation. Step S310 checks whether the induced voltage is in the late commutation voltage area LATE_AREA. In the case of a two-strand stator this is done, for example, by evaluating signal U2.

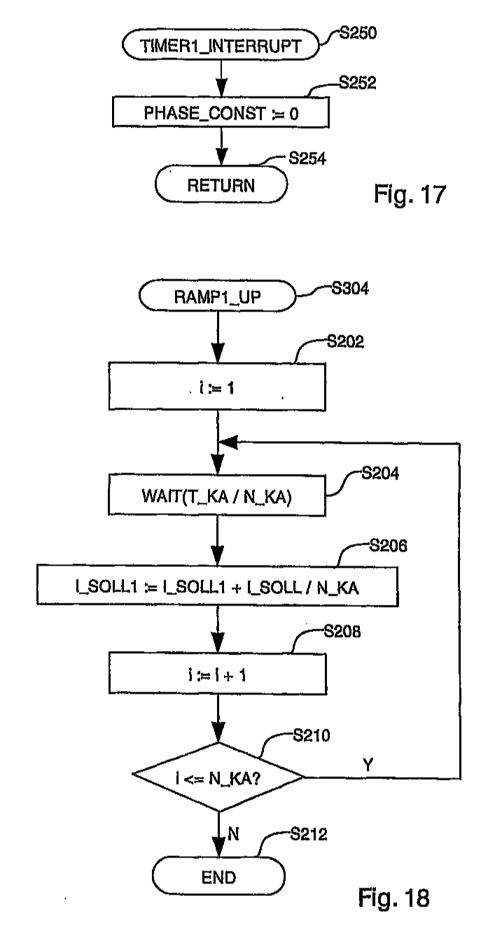

If a late commutation operation is not taking place in the time phase of constant current flow, execution branches respectively from step S310 to step S312. Step S312 checks whether the time phase of constant current flow should continue to be implemented. This is done by way of the PHASE_CONST variable, which is previously set to 1 and which, upon expiration of the time entered in timer TIMER1, is set to 0 by the “TIMER1_INTERRUPT” interrupt routine S250 of FIG. 17. Execution thus branches to step S320 upon expiration of the calculated time for the time phase of constant current flow, and the commutation initiation operation is initiated by calling the “RAMP1_DOWN” routine.

If, on the other hand, a late commutation operation is taking place during the time phase of constant current flow, execution then branches from step S310 to the “RESET_TIMER1” step S314. In this step, timer TIMER1 is reset so that an interrupt is no longer triggered. In step S316, late commutation duration T_LATE is then calculated from the difference between the present time t_TIMER and the starting instant of commutation completion operation t_KA. A correction of commutation duration T_K additionally takes place, by subtracting therefrom the late commutation duration T_LATE. Execution thereupon branches to step S320, and the “RAMP1_DOWN” commutation initiation operation S320 is initiated.

After the commutation initiation operation is complete, in step S322 a variable t_KE is set to the present time t_TIMER and an EARLY_COMMUT variable is set to 0. Step S324 checks whether an early commutation operation exists. This is done, for example, by way of voltage U1, and a check is made as to whether said voltage is in the EARLY_AREA early commutation area. In the case of an early commutation operation, execution branches to step S326 and the EARLY_COMMUT variable is set to 1 in order to indicate an early commutation operation. Execution then branches back to S324. As soon as voltage U1 is outside the EARLY_AREA early commutation area, execution branches to step S328. In the case of an early commutation operation, execution branches to step S330, where early commutation duration T_EARLY is calculated from the difference between present time t_TIMER and the time t_KE stored in step S322. A correction of commutation duration T_K is additionally performed, by increasing it by a value equal to early commutation duration T_EARLY. Execution thereupon branches to the end S332.

FIG. 17 shows the “TIMER1_INTERRUPT” interrupt routine S250. This routine is called upon expiration of the duration entered in step S306 of FIG. 16. In step S252 the PHASE_CONST variable is set to 0 in order to indicate the end of the time phase of constant current flow. Execution then branches back in step S254, and the main program continues.

FIG. 18 shows the “RAMP1_UP” routine S304 executing in μC 32, which routine performs commutation completion operation 107 for stator strand 16.

In step S202, commutation completion duration T_KA is calculated from commutation duration T_K (cf. description of FIG. 9). A loop counter i is set to 1. In step S204, execution is delayed for a time T_KA/N_KA. This is the time for one step of the commutation completion operation, and after N_KA steps the entire commutation completion duration T_KA has elapsed. After the delay time in step S204, in step S206 target current value I_SOLL1 for rotation speed controller I_RGL1 48 of FIG. 1 is increased by a value I_SOLL/N_KA. The result of this is that the desired target value I_SOLL is reached after N_KA steps.

In step S208 the loop variable i is incremented by 1, and step S210 checks whether all N_KA steps have not yet been carried out. If Yes, execution jumps back to step S204 and the next step of ramp 107 is generated. After all N_KA steps have been carried out, the “RAMP1_UP” routine S200 is ended.

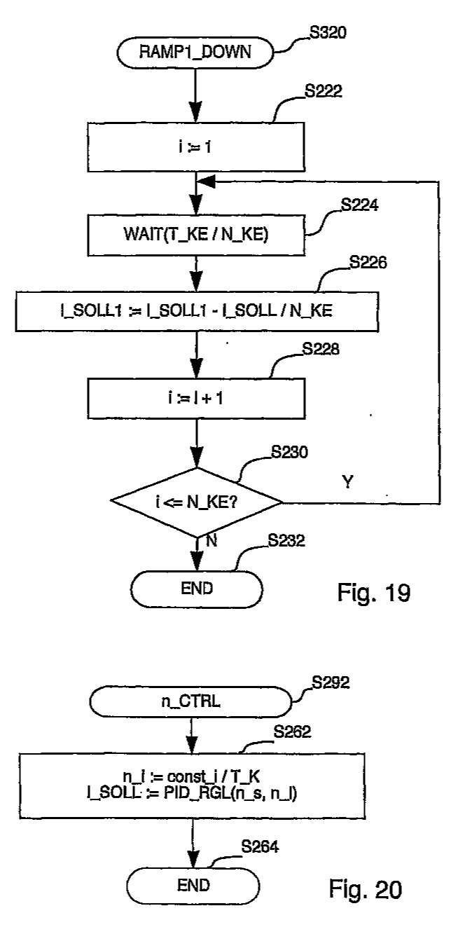

FIG. 19 shows a corresponding “RAMP1_DOWN” routine S320 for commutation initiation operation 109 (cf. FIG. 9). Routine S320 corresponds in terms of structure to the “RAMP1_UP” routine S304, but in the loop S224 to S230, what takes place at each step is firstly the decrease in target value I_SOLL1 in step S224, and only then the delay time in step S226.

The corresponding “RAMP2_UP” and “RAMP2_DOWN” routines for specifying target value I_SOLL2 for regulator I_RGL2 68 correspond to routines S304 of FIG. 18 and S320 of FIG. 19, but current flow occurs through second stator strand 18.

FIG. 20 shows the “n_CTRL” rotation speed regulation function S292 of FIG. 14. Step S262 calculates the actual rotation speed n_i, which is equal to the quotient of a constant const_i and commutation duration T_K. The calculated actual rotation speed n_i and target rotation speed n_s are delivered, in this exemplifying embodiment, to a PID controller PID_RGL, and the latter calculates current target value I_SOLL, which indicates the magnitude of the current during the time phase of constant current flow. The “n_CTRL” routine ends in step S264.

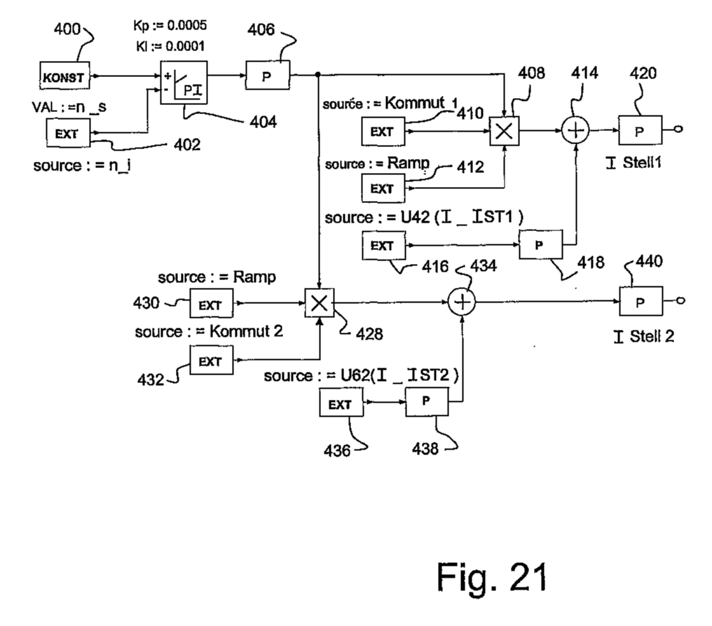

FIG. 21 is a block diagram of a current regulator and rotation speed controller for an electric motor 10 according to the present invention. A block 400 supplies a target rotation speed n_s to a block 404, and a block 402 supplies an actual rotation speed n_i to block 404. Block 404 is configured as a PI controller; the gain factor of proportional component kp=0.0005, and the gain factor of integral component Ki=0.0001. The output signal of block 404 is delivered to a block 406, block 406 being configured as a proportional element, in particular as an amplifier. The output signal of block 406 is delivered to blocks 408 and 428.

Also delivered to block 408 are a Kommut1 signal from a block 410, and a Ramp signal from a block 412. The Kommut1 signal specifies when current flow is to occur through the first strand; the Ramp signal specifies the ramp shape, which is a function of commutation duration T_K; and the signal from block 406 specifies the amplitude of the ramp-shaped commutation signal occurring in block 408, in order to influence the rotation speed. Block 408 is configured as a multiplier.

The commutation signal generated by block 408 is delivered to a block 414. Block 416 makes available a signal that corresponds to voltage U42 at base resistor 42 of FIG. 1, and thus to actual current value signal I_IST1. The signal of block 416 is delivered to block 418, which is configured as a proportional element, in particular as an amplifier. Block 414 is configured as an adder, and from the difference between the target current value signal from block 408 and the actual current value signal from block 418, a control output is generated in the block functioning as a current regulator and is outputted, via a block 420 functioning as an amplifier, as control output signal ISte111 for first stator strand 16. The fact that the current regulation system does not act until shortly before block 420 yields a very fast current limiting response.

Blocks 428, 430, 432, 434, 436, 438, and 440 correspond to blocks 408 to 420, and control signal ISte112 for second stator strand 18 is generated therein.

Rotation speed regulation is implemented by the fact that the control output signal of PI controller 404 is delivered to multiplier 408 or multiplier 428, thereby determining the magnitude of the ramp current. A predetermined elevation in target rotation speed n_s would then, for example, cause the signal delivered to multiplier 408 to become greater, which results in a higher target current value and thus a higher motor current I1 or I2. The result is that rotor 12 rotates faster, and an adaptation of commutation duration T_K takes place until the electric motor exhibits a rotation speed n_i corresponding to target rotation speed n_s.

The rotation speed of the motor is thus determined by an interaction between rotation speed controller 404 and current regulator 414.

Many modifications are of course possible within the scope of the invention.

In a simpler configuration, for example, the rotation speed controller in FIG. 21 can be omitted, by replacing blocks 400, 402, 404, and 406 with a block that outputs an adjustable signal. This results in an open-loop rotation speed control system.

An electric motor according to the present invention is preferably used to drive and/or decelerate a fan.

### Rotation Direction Detection

Because motor 10 is configured to generate an auxiliary reluctance torque, the rotation direction can be ascertained in area 108 of constant current flow from the slope of voltage U1 102, of voltage U1_ind 104, of voltage U2 103, and/or of voltage U2_ind (cf. FIG. 6).

In the case of the present motor, voltage U1 102 is rising, and the derivative of voltage U1 (which corresponds to the slope) is likewise positive. For a rotation in the opposite direction, conversely, the slope or derivative of voltage U1 would be negative.

The rotation direction measurement can be performed at least once after or during startup, or it can also occur at predetermined intervals.

The invention is not limited to the exemplifying embodiments that are depicted and described, but rather encompasses all embodiments that function identically, within the context of the invention.

What is claimed is:

1. A method of controlling an electric motor (10), which motor comprises
a permanently magnetic rotor (12),
a stator (14) having a winding (15), and
a power stage (40, 60) which influences the current (I1, I2) flowing through the winding (15),
which method comprises the steps of:
A) as a function of a desired commutation duration (T_K), defining a commutation period during which period the direction of a magnetic field generated by current flow through the winding is not modified, during which period a commutation completion operation (107) and a commutation initiation operation (109) take place, said commutation period starting at a first commutation instant (t_K_{N}) and ending at a second commutation instant (t_KN1);
B) temporally outside the commutation completion operation and the commutation initiation operation, the winding (15) at least at times experiences a substantially constant current flow, and sensing a voltage signal (U1, U2) dependent on a voltage (U1_ind, U2_ind) induced in the winding (15); and
C) modifying the commutation duration (T_K) as a function of the sensed voltage signal (U1, U2) in order to adapt said duration to the rotation speed of the rotor (12).

2.-25. (canceled)

26. An electric motor which adjusts commutation timing based upon detected values of voltages induced in a motor winding, which motor comprises:
a permanently magnetic rotor (12),
a stator (14) having a winding arrangement (15),
at least one power stage (40, 60) which influences the current (I1, I2) flowing through the winding arrangement (15),
a voltage sensing apparatus (86, 90) for sensing a voltage signal (U1, U2) dependent on the voltage induced in the winding arrangement (15),
a target current value specifying apparatus (36) to which the voltage signal (U1, U2) is delivered, and which generates therefrom a target current value signal (I_SOLL1, I_SOLL2) controlling operation of the electric motor,
and a current regulation apparatus (48, 68) to which the target current value signal is delivered, and which influences the power stage (40, 60) in such a way that current (I1, I2) flowing through the winding arrangement (15) is a function of the target current value signal.

27. The electric motor according to claim 26, wherein
the target current value specifying apparatus (36), during operation, generates an approximately trapezoidal target current value signal (I_SOLL1, I_SOLL2).

28. The electric motor according to claim 27, wherein
the target current value specifying apparatus (36) sets the target current value signal (I_SOLL1, I_SOLL2) along a plateau (108) of the trapezoid, during a predetermined time span, substantially to a predetermined high value (I_SOLL) in order to produce, during said time span, a substantially constant current through the winding arrangement (15).

29. The electric motor according to claim 28,
which comprises a rotation speed controller (32) which regulates the rotation speed to a predetermined target rotation speed value (n_s),
the rotation speed controller (32) outputting a control output, and
in which electric motor the high value (I_SOLL) for the target current value signal (I_SOLL1, I_SOLL2) along a plateau portion of the trapezoid is a function of said control output.

30. The electric motor according to claim 26, wherein
the current regulation apparatus (48, 68) is implemented as an analog current regulation apparatus.

31. The electric motor according to claim 26, further comprising
digitization apparatus (86, 90) that generates a digital voltage signal as a function of the voltage signal.

32. The electric motor according to claim 26, wherein
the target current value specifying apparatus (COMMUT) comprises a program and a microprocessor (32) which, in operation, executes said program.

33. The electric motor according to claim 26, wherein
the current regulation apparatus (48, 68) is configured in such a way that it enables regulation to a current of 0 A.

34. The electric motor according to claim 26, wherein
the winding arrangement (15) comprises one strand (16) having a first terminal (361) and a second terminal (362), and wherein
the first terminal (361) and the second terminal (362) are connected to the voltage sensing apparatus (36) in order to sense the voltage induced in said strand (16).

35. The electric motor according to claim 34, wherein
the power stage is configured as a full bridge circuit.

36. The electric motor according to claim 26, wherein
the winding arrangement (15) comprises at least two strands (16, 18), which are respectively connected, on a first side, to a voltage source (UZK) and, on a second side, to a terminal (MP_1, MP_2) and to a switch (40, 60), and wherein
the terminal (MP_1, MP_2) is respectively connected to the voltage sensing apparatus (86, 90).

37. The electric motor according to claim 36, wherein
the voltage source (UZK) comprises a voltage source terminal (MP_UZK) that is connected to the voltage sensing apparatus (86, 90).

38. (canceled)

39. The method of claim 1, further comprising
during each commutation period, picking up, from a winding, successive voltage signal values corresponding to
a plateau period (108) characterized by substantially constant current,
said commutation initiation period (109) characterized by voltage decreasing toward zero, and
said commutation completion period (107) characterized by voltage increasing from zero.

40. The method of claim 39, further comprising
measuring actual duration of at least one of said periods within said commutation period, and
comparing said measured actual duration with a target duration value.

41. The method of claim 40, further comprising
adjusting a voltage profile of voltage applied to said at least one winding (15) to reduce any deviation of said measured actual duration from said target duration value.

42. The method of claim 41, wherein said adjusting step comprises ascertaining
a value Tspät representing a later-than-optimal occurrence of a commutation instant, and thereafter reducing duration of a subsequent commutation period.

43. The method of claim 41, wherein said adjusting step comprises ascertaining
a value Tfrüh representing an earlier-than-optimal occurrence of a commutation instant, and thereafter increasing duration of a subsequent commutation period.

44. The method of claim 39, wherein said picking up voltage values comprises, in a single-strand motor, picking up voltage values from said single strand while current is flowing therethrough.

45. The method of claim 39, wherein said picking up voltage values comprises, in multi-strand motor, picking up values of voltage induced in a strand other than a strand then carrying current.

46. The method of claim 39, further comprising applying said voltage signals to inputs (84,88) of a microprocessor (32) and generating output signals (52,72) from said microprocessor which control current applied to said at least one winding.

47. The method of claim 46, further comprising detecting, from said voltage signals, a direction of rotation of said rotor, and applying a rotation direction signal (44) to a further input (80) of said microprocessor.

48. The method of claim 46, further comprising controlling current applied to said at least one winding by applying said control signals (52, 72) from said microprocessor (32) to a current regulator (48, 68) and applying output signals (54, 74) from said current regulator to control (40,60) current in said at least one winding.
